(19) United States
(12) Patent Application Publication
(10) Pub. No.: US 2011/0226551 A1
(43) Pub. Date: Sep. 22, 2011

(54) QUICK-RELEASE LADDER STABILIZER AND LEVELER

(75) Inventors: GREG IVERSON, LAKE OSWEGO, OR (US); ERIC JOHNSON, WOOD VILLAGE, OR (US)

(73) Assignee: THORSTAND LLC, LAKE OSWEGO, OR (US)

(21) Appl. No.: 13/118,537

(22) Filed: May 30, 2011

Related U.S. Application Data
(63) Continuation-in-part of application No. 12/985,702, filed on Jan. 6, 2011.
(60) Provisional application No. 61/294,451, filed on Jan. 12, 2010.

(51) Int. Cl. E06C 7/00

(52) U.S. Cl. 182/107

(57) ABSTRACT

A quick-release ladder stabilizer and leveler that is fast and easy to use. The combined ladder stabilizer and leveler levels a ladder on sloping, uneven, or stepped surfaces, significantly broadens the ladder base for stability, retrofits to existing ladders without ladder modification, and in addition is fast to attach/remove, easy to adjust by a single user, and readily portable.

### CROSS-REFERENCE TO RELATED APPLICATIONS

This application is a continuation-in-part of U.S. patent application Ser. No. 12/985,702 filed on 2011-01-06, which application claims priority to US Provisional Patent Application No. 61/294,451 filed on 2010 January 12, which applications are incorporated herein by reference in their entirety.

### TECHNICAL FIELD

Disclosed embodiments relate to ladder stabilizer and leveler apparatuses.

### BACKGROUND

Ladder falls are a leading industrial safety issue. There are approximately 200,000 ladder related accidents in the United States each year. Standard commercial ladders are inherently unstable due to their narrow base width, and feet designed for level placement. Often, users of these ladders need to lean or carry awkward loads while on ladders placed on sloping, uneven, or stepped surfaces and this combination can result in the center of gravity of the ladder load extending beyond the ladder feet, thereby placing the user at high risk of a ladder fall.

Numerous ladder leveler designs (e.g. U.S. Pat. No. 5,542,497) disclose extendable substitute ladder feet in order to keep the ladder rails vertical when placed on inclined ground. However, these designs do not significantly widen the ladder base and therefore the ladder remains prone to tipping.

Numerous ladder stabilizer designs (e.g. U.S. Pat. No. 6,527,084) disclose pivoting telescoping support feet extending from the ladder to ground at a distance from the ladder. These designs provide a measure of stabilization against lateral movement of the ladder, however, they are generally unsuited for stabilization if one of the ladder feet is not in contact with the ground or the ladder rails are not vertical.

U.S. Pat. No. 6,336,521 discloses a ladder leveling device with an arch structure that fails the ANSI/OSHA requirements that the first rung, in this case the arch, is flat and that rung-spacing is twelve inches. Furthermore, since widening the arch base increases the height of the arch and ANSI standards require that the first rung (the arch) is no higher than fourteen inches off the ground, the arch base width is restricted, and consequently the stability of the ladder leveling device is limited.

U.S. Pat. No. 1,424,934 discloses a ladder leveler for use on hillsides. The ladder leveler requires permanent ladder modification, and is not readily separable from the ladder. Furthermore, the leveler significantly obstructs foot placement on the first rung of the ladder, and thus violates OSHA safety requirements.

U.S. Pat. No. 5,507,364 discloses a ladder leveling/stabilizing device which is not readily separable from the ladder and which utilizes a friction-based locking mechanism that can fail if not tightened sufficiently by the ladder user, or if exposed to lubricants. Furthermore, the leveler significantly obstructs foot placement on the first rung of the ladder.

Most ladder leveler and/or stabilizer designs require permanent ladder modifications (such as drilling of holes), which can compromise ladder integrity and void ladder warranty. Furthermore, ladder levelers/stabilizers that do not implement quick-release mechanisms for ladder attachment hinder their usage with multiple ladders and can make ladder transportation more difficult. Those that are designed to retrofit without modification are typically time-consuming to install/remove, or difficult for one person to adjust without assistance.

### SUMMARY

Clearly, there is a need for a combined ladder stabilizer and leveler that levels a ladder on sloping, uneven, or stepped surfaces, significantly broadens the ladder base for stability, retrofits to existing ladders without ladder modification, and in addition is fast to attach/remove, easy to adjust by a single user, and readily portable.

Disclosed embodiments of the stabilizer and leveler for a ladder include: (a) a base assembly; (b) two feet respectively attached to the left and right sides of the base assembly; (c) a ladder harness assembly pivotally attached to the base assembly, the ladder harness assembly comprising means for removably attaching the ladder harness assembly to a ladder; (d) retaining means for preventing separation of the ladder harness assembly from the base assembly; and (e) selective locking means for preventing rotation of the ladder harness assembly relative to the base assembly when the selective locking means is engaged.

### BRIEF DESCRIPTION OF THE DRAWINGS

Disclosed embodiments are illustrated by way of example, and not by way of limitation, in the figures of the accompanying drawings.

FIG. 1 illustrates a front elevation of an embodiment of the quick-release ladder stabilizer and leveler with attached ladder on inclined ground surface.

FIG. 2 illustrates a side elevation of an embodiment of the quick-release ladder stabilizer and leveler with attached ladder.

FIG. 3 illustrates a front elevation of an embodiment of the quick-release ladder stabilizer and leveler with attached ladder.

FIG. 4 illustrates a rear elevation of an embodiment of the quick-release ladder stabilizer and leveler with attached ladder.

FIG. 5 illustrates a front perspective exploded view of an embodiment of the quick-release ladder stabilizer and leveler.

FIG. 6 illustrates a rear perspective exploded view of an embodiment of the quick-release ladder stabilizer and leveler.

FIG. 7 illustrates a front elevation of an embodiment of the lightweight quick-release ladder stabilizer and leveler with attached ladder on inclined ground surface.

FIG. 8 illustrates a side elevation of an embodiment of the lightweight quick-release ladder stabilizer and leveler with attached ladder.

FIG. 9 illustrates a front elevation of an embodiment of the lightweight quick-release ladder stabilizer and leveler with attached ladder.

FIG. 10 illustrates a rear elevation of an embodiment of the lightweight quick-release ladder stabilizer and leveler with attached ladder.

FIG. 11 illustrates a front perspective exploded view of an embodiment of the lightweight quick-release ladder stabilizer and leveler.

FIG. 12 illustrates a rear perspective exploded view of an embodiment of the lightweight quick-release ladder stabilizer and leveler.

### DETAILED DESCRIPTION

A. Quick-Release Ladder Stabilizer and Leveler

A.1. First Embodiment

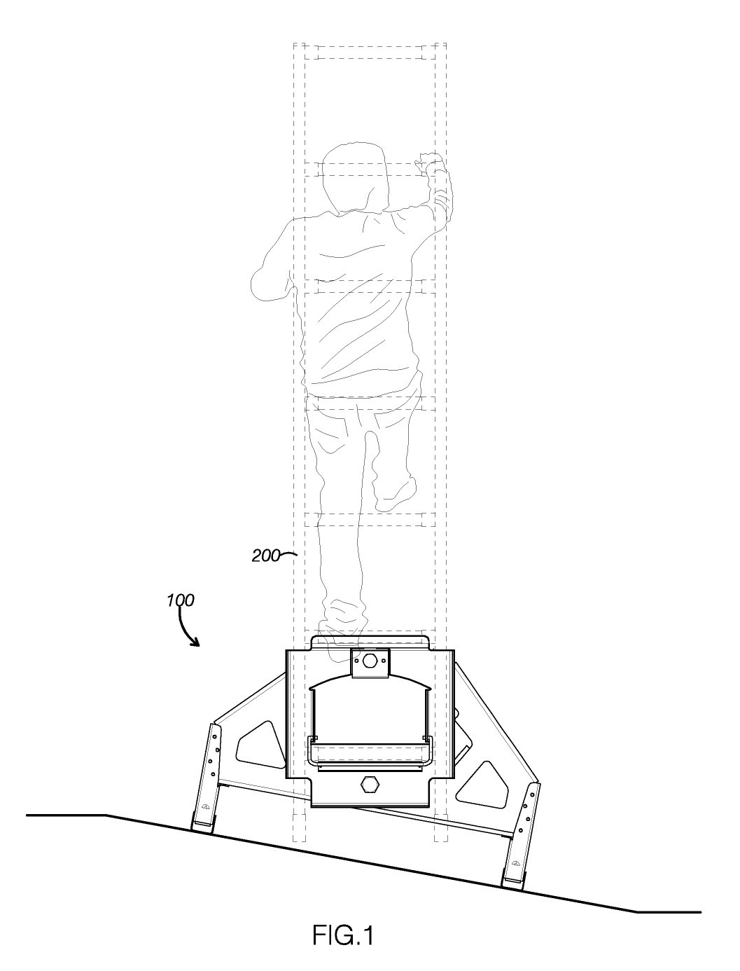

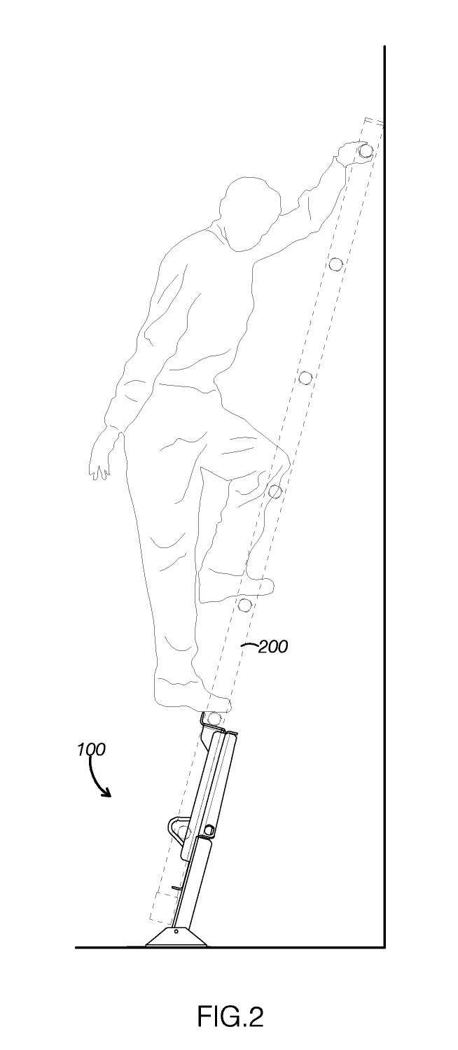

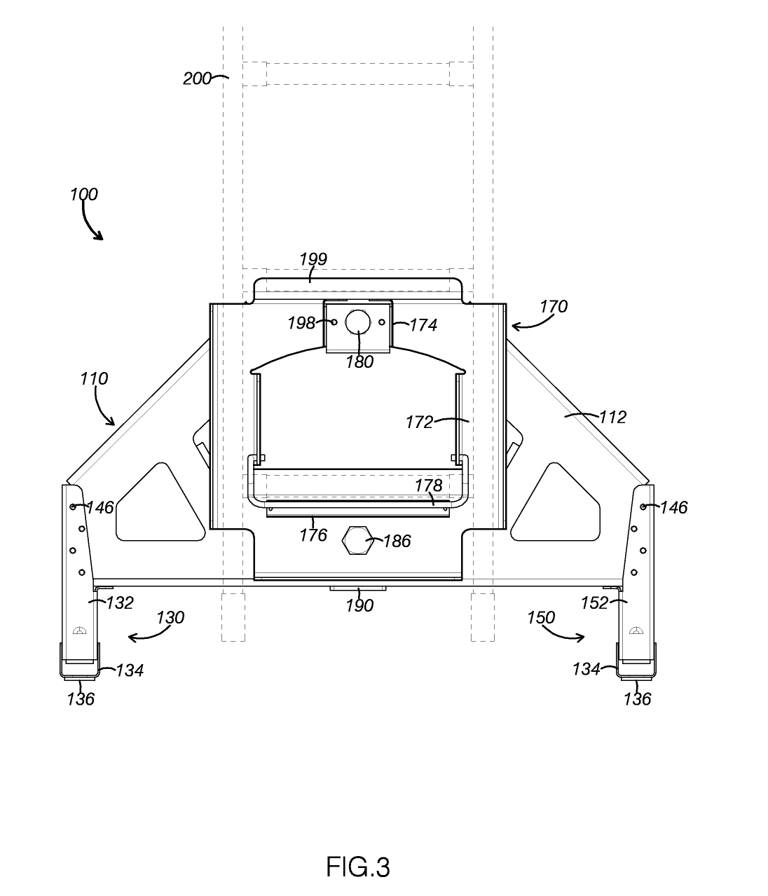

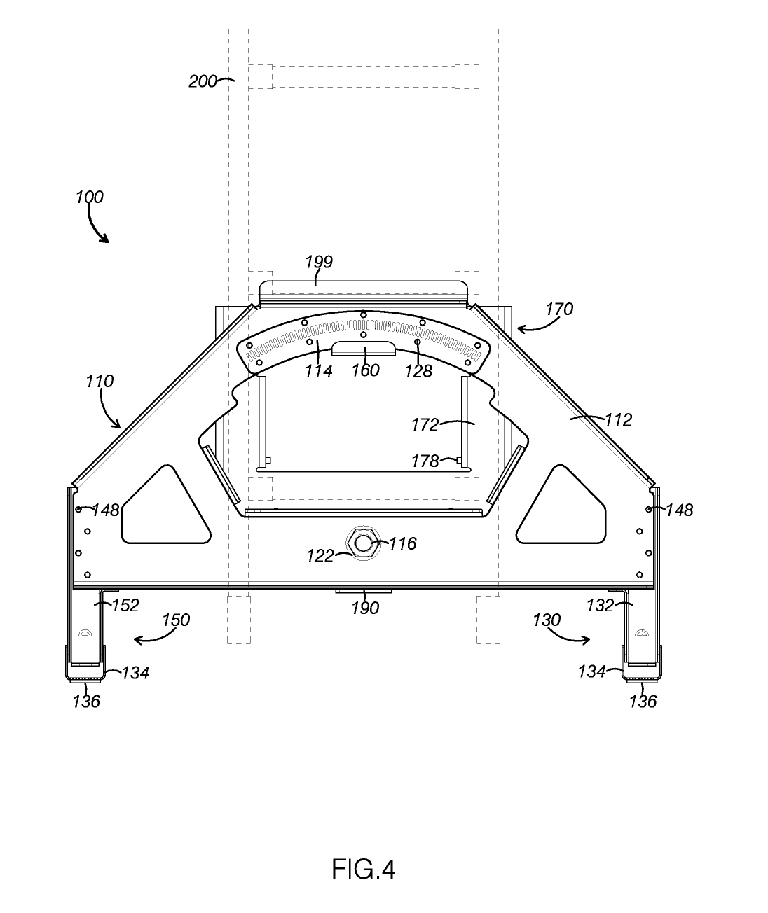

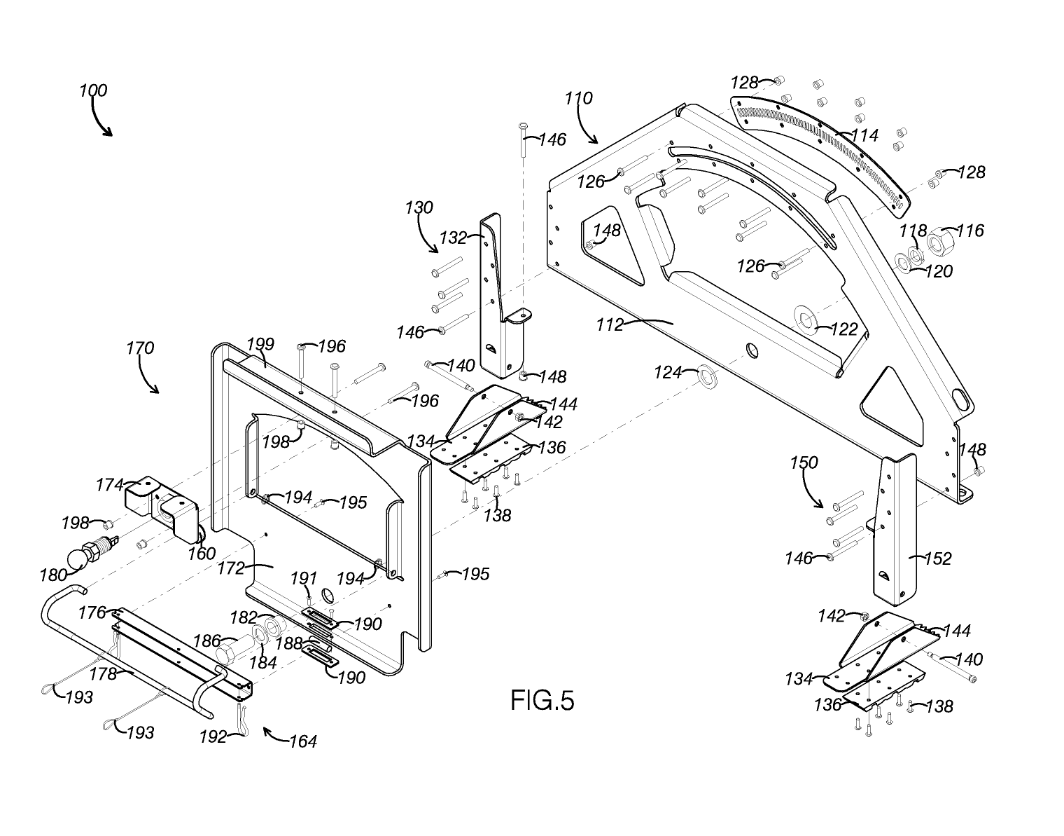

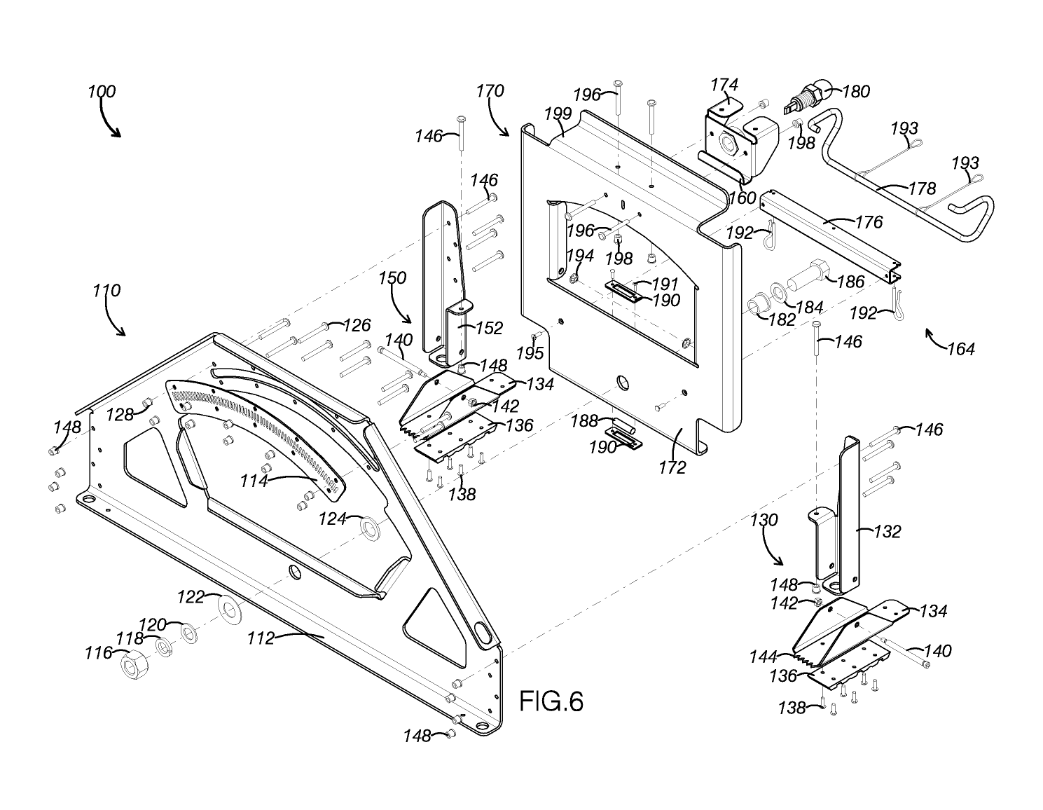

A first embodiment of the quick-release ladder stabilizer and leveler 100 is shown in FIGS. 1-6.

The base assembly 110 is a rigid truss-like structure 112 formed from aluminum alloy sheeting with cutouts and flanges. The base assembly 110 provides a strong support for the ladder harness assembly 170, which is attached to the base assembly 110 by a ladder harness pivot 186. The weight of the ladder 200 and its load are transferred from the ladder harness assembly 170 to the base assembly 110 via the ladder harness pivot 186. The ladder harness locking mechanism cutout at the top of the base assembly 110 limits the rotation of the ladder harness assembly 170 to within a 60 degree range.

The leg assemblies 130 and 150 include leg struts 132 and 152, leg strut fasteners 146 and 148, feet 134, foot pivots 140, foot pivot retainers 142, foot pads 136, and foot pad fasteners 138. The leg assemblies 130 and 150 are constructed of steel, with the exception of the foot pads 136 which are rubber. The feet 134 have a serrated edge 144 to provide additional grip when the quick-release ladder stabilizer and leveler 100 is mounted on soft surfaces. The leg struts 132 and 152 are riveted to the base assembly 110 and provide a stable footing for the base assembly 110. The distance between the feet 134 is approximately twice the width of the ladder 200. Since the center of gravity of the ladder load must extend beyond the feet 134 before the ladder 200 can fall, the quick-release ladder stabilizer and leveler 100 provides a high degree of stability to the ladder 200.

The ladder harness assembly 170 includes a back-plate 172, an upper rung bracket 199, lower rung retainer 164, ladder harness pivot 186, and ladder harness pivot fasteners 184, 182, 124, 122, 120, 118, and 116. The back-plate 172 and upper rung bracket 199 are constructed out of a single piece of formed aluminum alloy sheeting. The lower rung retainer channel 176 is constructed of aluminum alloy. The other lower rung retainer components 178, 192, 193, 194, and 195, ladder harness pivot 186, and ladder harness pivot fasteners 184, 182, 124, 122, 120, 118, and 116 are constructed of steel. The ladder harness assembly 170 is pivotally attached to the base assembly 110 by a ladder harness pivot 186 and ladder harness pivot fasteners 184, 182, 124, 122, 120, 118, and 116. The rotatable ladder harness assembly 170, to which the ladder 200 is removably attached, permits rapid leveling of the ladder 200 on a variety of surface inclines or footing levels. The bubble level 188, retained between bubble level plates 190 and secured with bubble level fasteners 191, serves as an aid for leveling the ladder 200.

Several components of the ladder harness assembly 170 support or laterally retain the ladder 200; however, actual securement/release of the ladder 200 is implemented by the lower rung retainer 164. The lower rung retainer 164 comprises a wire clip 178, lower rung retainer channel 176, cotter pins 192, and cables 193. The ends of the wire clip 178 are inserted into flange mount holes in the back-plate 172 and are secured using wire clip fasteners 194. The lower rung retainer channel 176 is attached to the back-plate 172 using lower rung retainer fasteners 195. The cotter pins 192 are attached to the wire clip 178 by the cables 193. The wire clip 178 is rotated down and over the first rung of the ladder 200 and is secured in the lower rung retainer channel 176 by the cotter pins 192. Once the wire clip 178 is secured, the first rung of the ladder 200 is retained laterally between the wire clip 178 and the back-plate 172; the second rung of the ladder 200 is laterally retained between the top lip of the upper rung bracket 199 and the back-plate 172. The weight of the ladder 200 and its load is supported by the upper rung bracket 199. Once the wire clip 178 is released the ladder 200 can be removed by lifting the second rung of the ladder 200 over the top lip of the upper rung bracket 199. Thus the quick-release ladder stabilizer and leveler 100 can be readily used with different ladders as the need arises. Furthermore, ease of separation of the ladder 200 from the quick-release ladder stabilizer and leveler 100 facilitates portability of both.

The base assembly retainer lip 160, extending from the plunger support bracket 174, overlaps a far-side portion of the base assembly 110 so as to maintain close proximity between the ladder harness assembly 170 and the base assembly 110. In this way, the base assembly retainer lip 160 maintains the coplanarity of the ladder harness assembly 170 and base assembly 110 under any ladder load or rotational position of the ladder harness assembly 170, thus relieving stress on the ladder harness pivot 186.

The ladder harness locking mechanism 180, 174, and 114 comprises a spring-loaded plunger 180, plunger support bracket 174, and locking plate 114. The spring-loaded plunger 180, plunger support bracket 174, and locking plate 114 are constructed of steel. The plunger support bracket 174 is attached to the ladder harness assembly 170 using plunger support bracket fasteners 196 and 198. The spring-loaded plunger 180 is housed within the plunger support bracket 174. The locking plate 114 is attached to the base assembly 110 using locking plate fasteners 126 and 128. The locking plate 114 has multiple slots for capturing the retractable end of the spring-loaded plunger 180, and the retractable end of the spring-loaded plunger 180 is by default extended to engage with the slots in the locking plate 114. The locking mechanism is disengaged by pulling the knob of the spring-loaded plunger 180 against internal spring resistance. The ladder harness locking mechanism 180, 174, and 114 is designed to allow the ladder harness assembly 170 to lock at specific angles in order to hold the rails of the ladder 200 in a vertical orientation. Additionally, the ladder harness locking mechanism 180, 174, and 114 is a positive locking mechanism that resists accidental disengagement due to vibration or rotational torque of the ladder harness assembly 170. Furthermore, the ladder harness locking mechanism 180, 174, and 114 can be engaged and disengaged single-handedly and rapidly without the aid of tools, permitting fast leveling of the ladder 200 by a single user.

The overlapping open space within the base assembly 110 and ladder harness assembly 170 respectively permits a ladder user's foot to be placed on the first rung of the ladder 200 without significant obstruction. Unimpeded and normal placement of a user's foot on top of the central 12 inches of the first rung of the ladder 200 is provided. The top surface of the second rung of the ladder 200 clears the top of the upper rung bracket 199 and therefore placement of a user's foot on that rung or any subsequent rung is entirely unimpeded. Since use of the quick-release ladder stabilizer and leveler 100 with the ladder 200 does not alter the stepping distance between the first and second rungs of the ladder 200, ANSI/OSHA requirements regarding rung spacing are met. Furthermore, since use of the quick-release ladder stabilizer and leveler 100 on level ground does not elevate the height of the first rung above fourteen inches from the ground, ANSI/OSHA ladder requirements regarding first rung height are met. Indeed, the quick-release ladder stabilizer and leveler 100 meets or exceeds all relevant ANSI A14 ladder requirements for ladder types III through IA.

As a result of the foregoing, stability and vertical rail orientation of ladder 200 can be achieved on a variety of ground surfaces and inclines by placing the base assembly 110 on a ground surface, mounting the ladder 200 onto the ladder harness assembly 170, rotating the ladder harness assembly 170 to achieve vertical ladder rail orientation, and locking the ladder harness assembly 170 to maintain vertical ladder rail orientation.

The quick-release ladder stabilizer and leveler 100 of the aforementioned embodiment fits aluminum and fiberglass extension ladders of lengths up to 32 feet, encompassing approximately ninety percent of commercial extension ladders.

A.2. Alternate Embodiments

Alternative embodiments of the quick-release ladder stabilizer and leveler 100 include use of various materials or combinations of materials, such as aluminum, magnesium, or titanium, or alloys of the foregoing.

Alternate embodiments of the base assembly 110 include base assemblies of various widths to meet other size and stability requirements. Several other structural configurations, such as trusses or arches, are possible without departing from the spirit of the disclosed embodiments.

Alternative embodiments of the leg assemblies include telescoping feet in order to provide ladder stability and leveling on steps. Various feet shapes or forms, such as circular, non-pivoting, with holes to permit staking, or custom formed for particular applications are possible without departing from the spirit of the disclosed embodiments.

Alternative embodiments of the lower rung retainer 364 use a differently formed wire clip 178 to suit various types of ladder rungs, or a wire clip 178 with a non-slip coating on its upper surface above the first rung.

Alternative embodiments of the lower rung retainer 364 retain the first rung of the ladder 200 in a horizontally oriented lower rung retaining channel attached to the bottom plate 372 so as to enclose the back, top and bottom surfaces of the first rung of a ladder. A channel locking pin is inserted through a hole in the lower rung retaining channel in front of the first rung in order to retain it in the lower rung retaining channel.

B. Lightweight Quick-Release Ladder Stabilizer and Leveler

B.1. First Embodiment

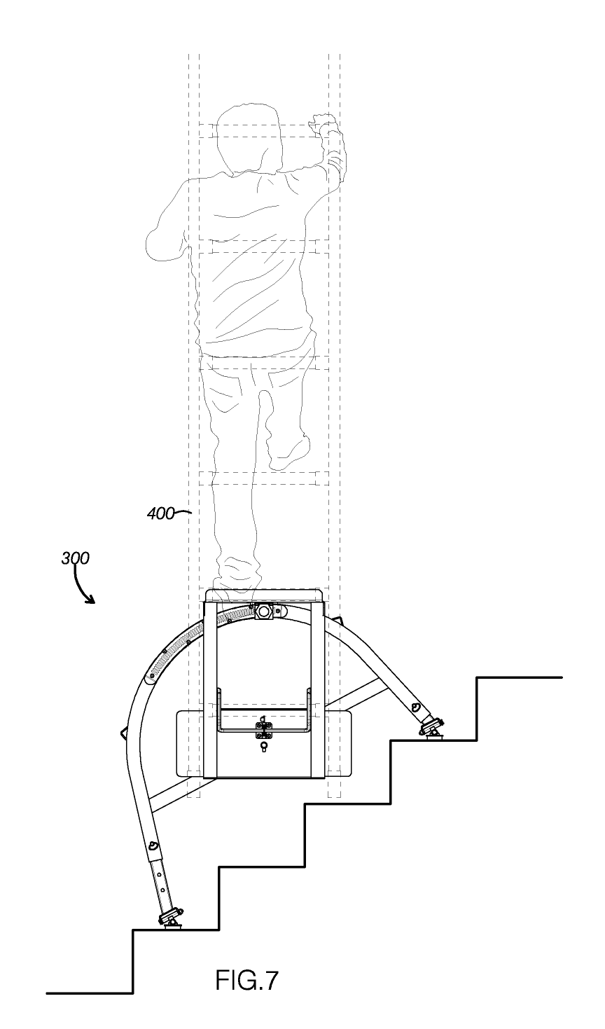

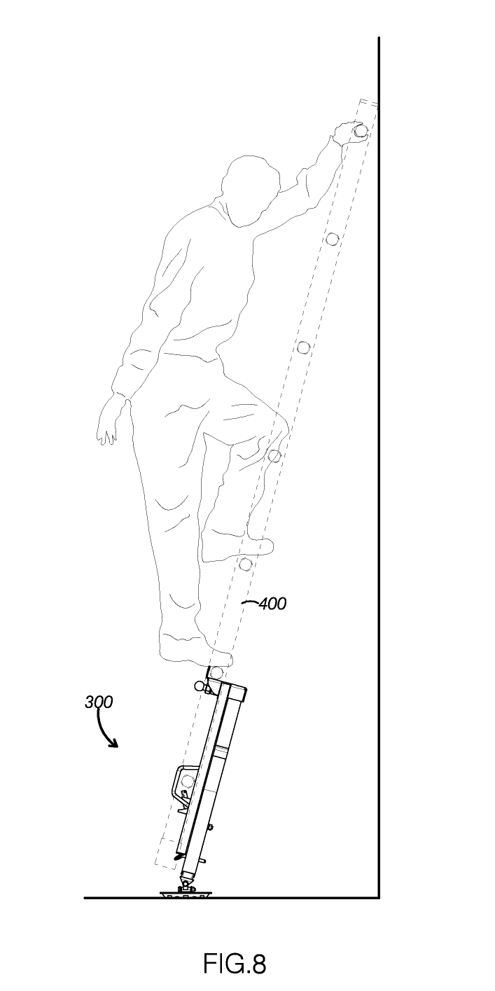

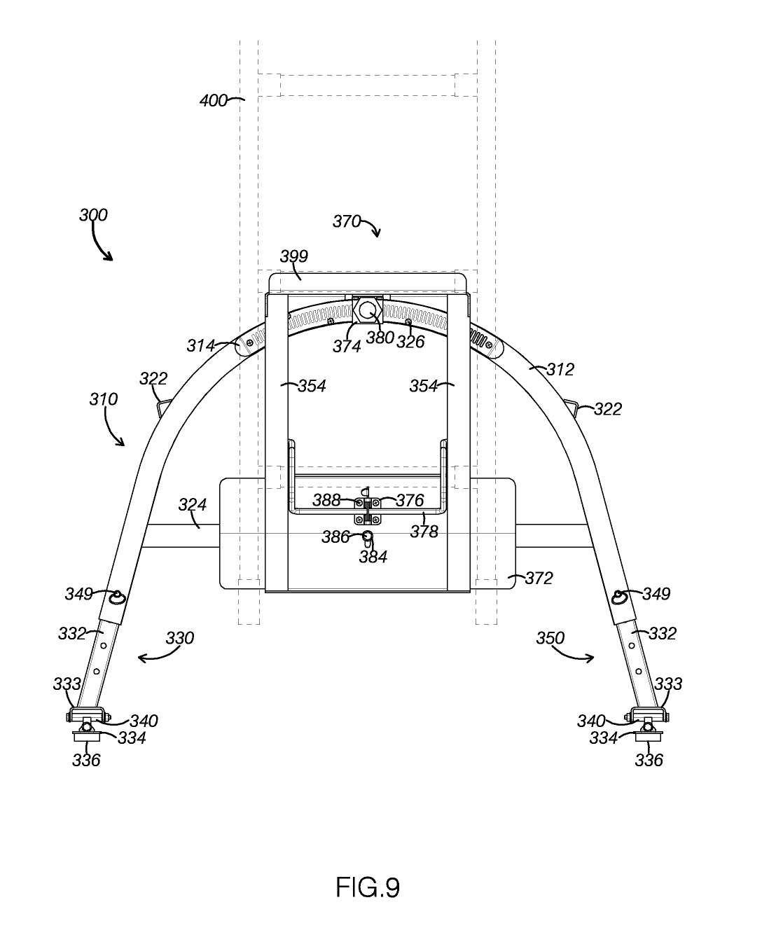

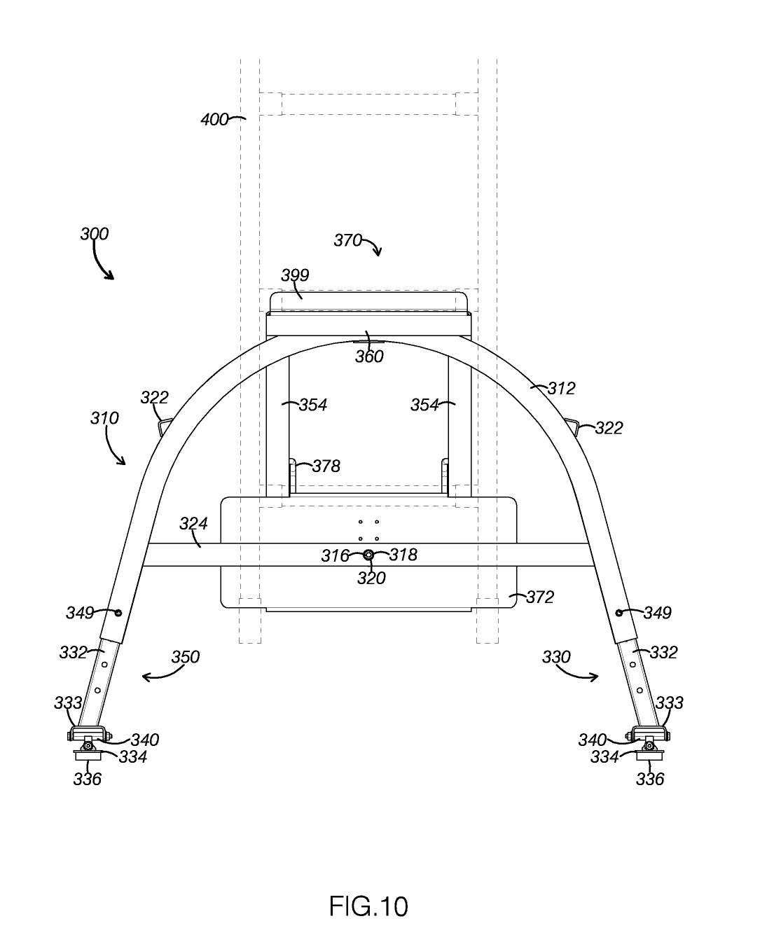

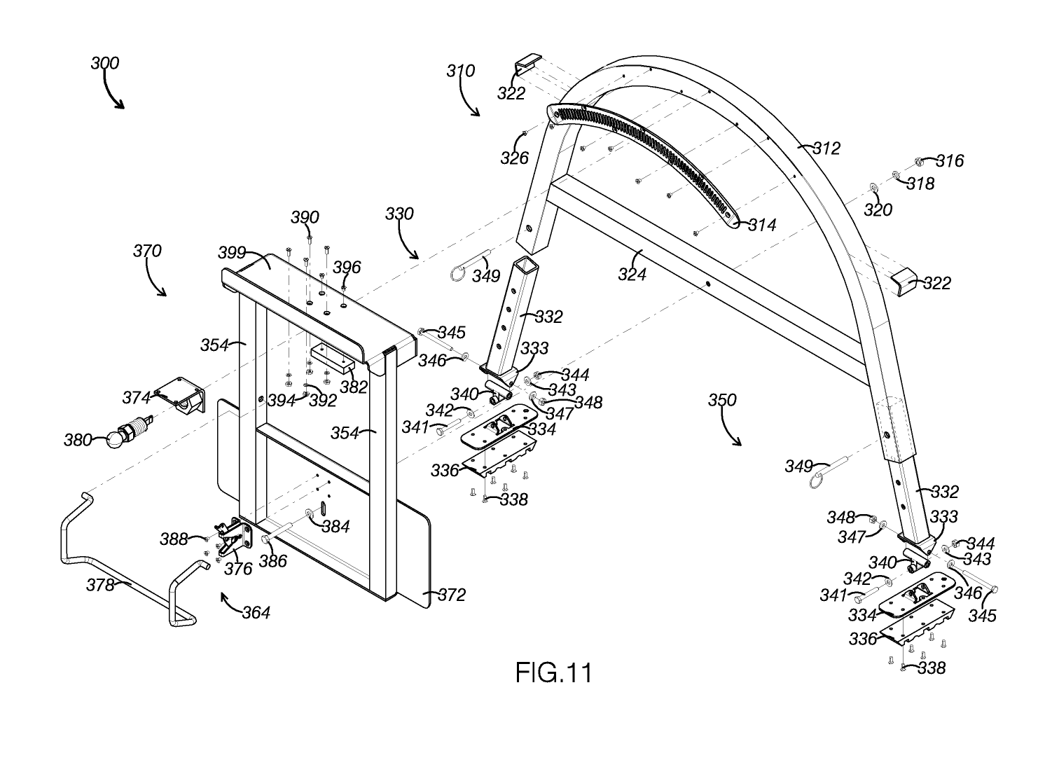

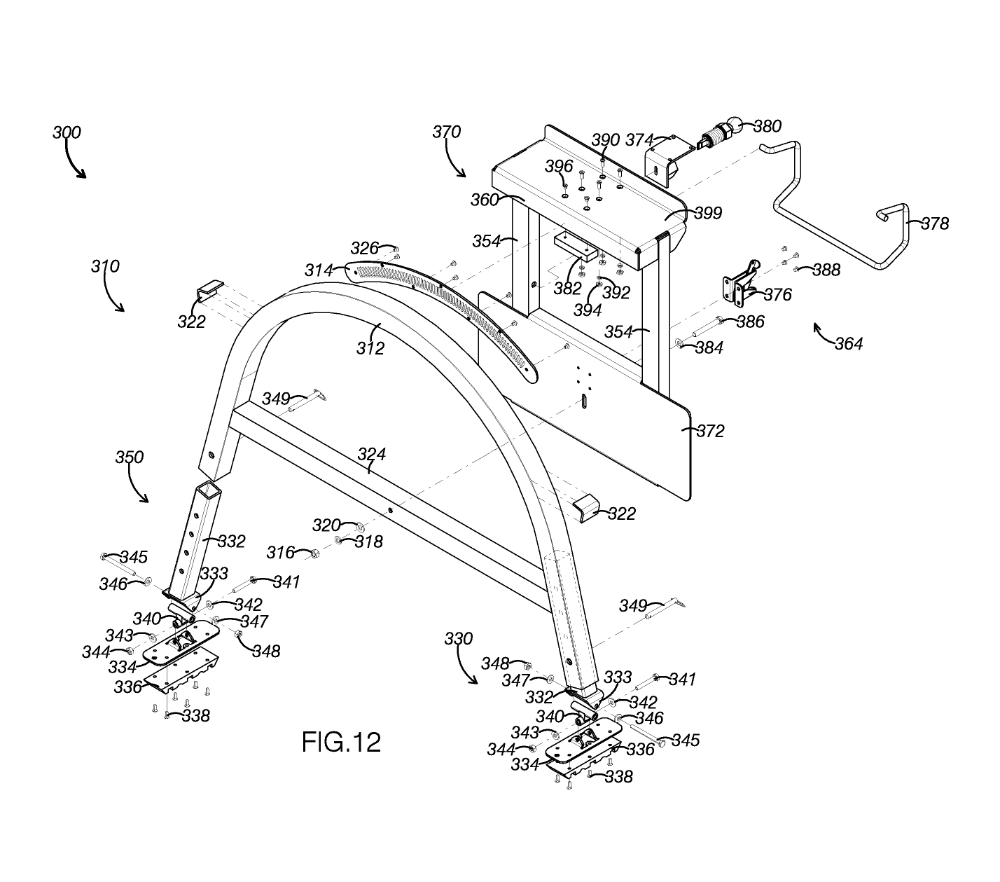

A first embodiment of the lightweight quick-release ladder stabilizer and leveler 300 is shown in FIGS. 7-12.

The base assembly 310 comprises an arched member 312, cross-brace 324, and ladder harness stops 322. The arched member 312 and cross-brace 324 are constructed of extruded aluminum alloy tubing. The arched member 312 comprises an arch section and two straight sections, one at each end of the arch section. The cross-brace 324 supports the ladder harness pivot 386, however the weight of the ladder 400 and its load are transferred from the ladder harness assembly 370 via the bushing 382 to the arched member 312. The substantially arched shape of the arched member 312 provides a strong and lightweight support for the ladder harness assembly 370. The ladder harness stops 322 limit the rotation of the ladder harness assembly 370 to within a 90 degree range.

The leg assemblies 330 and 350 comprise leg struts 332, foot brackets 333, cross-directional pivot components 340, 341, 342, 343, 344, 345, 346, 347, and 348, feet 334, foot pads 336, foot pad fasteners 338, and locking pins 349. The leg struts 332 are constructed of extruded aluminum alloy tubing. The foot brackets 333 and feet 334 are constructed of aluminum alloy. The foot pads 336 are rubber. The cross-directional pivot components 340, 341, 342, 343, 344, 345, 346, 347, and 348, foot pad fasteners 338, and the locking pins 349, are constructed of steel. The cross-directional pivots allow the feet 334 to swivel to match any surface incline. The leg struts 332 insert into the straight sections of the arched member 312 and provide a stable footing for the base assembly 310. The extended/retracted position of the feet 334 can be rapidly and easily adjusted/secured through use of the locking pins 349. The distance between the feet 334 (when retracted) is approximately twice the width of the ladder 400. Since the center of gravity of the ladder load must extend beyond the feet 334 before the ladder 400 can fall, the lightweight quick-release ladder stabilizer and leveler 300 provides a high degree of stability to the ladder 400.

The ladder harness assembly 370 comprises a upper rung bracket 399, bushing components 382 and 396, sidebars 354, bottom plate 372, lower rung retainer 364, ladder harness pivot 386, and ladder harness pivot fasteners 384, 320, 318, and 316. The sidebars 354 are constructed of extruded aluminum alloy tubing. The upper rung bracket 399 and bottom plate 372 are constructed of formed aluminum alloy sheeting. The lower rung retainer 364, ladder harness pivot 386, and ladder harness pivot fasteners 384, 320, 318, and 316 are constructed of steel. The bushing 382 is constructed of nylon. The ladder harness assembly 370 is pivotally attached to the base assembly 310 by the ladder harness pivot 386 and ladder harness pivot fasteners 384, 320, 318, and 316. The ladder harness pivot 386 passes through a vertically oriented oblong hole in the bottom plate 372, such that the weight of the ladder 400 and its load are not transferred from the ladder harness assembly 370 to the cross-brace 324. The oblong hole also permits the ladder harness assembly 370 and bushing 382 to be raised slightly, thus assisting in rotation of ladder harness assembly 370 by reducing friction between the bushing 382 and the arched member 312. The rotatable ladder harness assembly 370, to which the ladder 400 is attached, permits rapid leveling of the ladder 400 on a variety of surface inclines or footing levels.

Several components of the lightweight quick-release ladder stabilizer and leveler 300 support or laterally retain the ladder 400; however, actual securement/release of the ladder 400 is implemented by the lower rung retainer 364. The lower rung retainer 364 comprises a wire clip 378 and a latch 376, which is a gate-type latch. The ends of the wire clip 378 are mounted in the sidebars 354. The latch 376 is attached to the bottom plate 372 using latch fasteners 388. The wire clip 378 is rotated down and over the first rung of the ladder 400 and is secured by the latch 376. Once the wire clip 378 is secured, the first rung of the ladder 400 is laterally retained between the wire clip 378 and the sidebars 354 and the second rung of the ladder 400 is laterally retained between the upper rung bracket 399 and the arched member 312. The weight of the ladder 400 and its load is supported by the upper rung bracket 399. Once the wire clip 378 is released the ladder 400 can be removed by lifting the second rung of the ladder 400 over the top lip of the upper rung bracket 399. Thus the lightweight quick-release ladder stabilizer and leveler 300 can be readily used with different ladders as the need arises. Furthermore, ease of separation of the ladder 400 from the lightweight quick-release ladder stabilizer and leveler 300 facilitates portability of both.

The base assembly retaining lip 360, extending from the upper rung bracket 399, overlaps a far-side portion of the arched member 312 so as to maintain close proximity between the ladder harness assembly 370 and the base assembly 310. In this way, the base assembly retaining lip 360 maintains the coplanarity of the ladder harness assembly 370 and base assembly 310 under any ladder load or rotational position of the ladder harness assembly 370, thus relieving stress on the ladder harness pivot 386.

The ladder harness locking mechanism 380, 374, and 314 comprises a spring-loaded plunger 380, plunger support bracket 374, and locking plate 314. The spring-loaded plunger 380, plunger support bracket 374, and locking plate 314 are constructed of steel. The plunger support bracket 374 is attached to the ladder harness assembly 370 using plunger support bracket fasteners 390, 392, and 394. The spring-loaded plunger 380 is housed within the plunger support bracket 374. The locking plate 314 is attached to the arched member 312 using locking plate fasteners 326. The locking plate 314 has multiple slots for capturing the retractable end of the spring-loaded plunger 380, and the retractable end of the spring-loaded plunger 380 is by default extended to engage with the slots in the locking plate 314. The locking mechanism is disengaged by pulling the knob of the spring-loaded plunger 380 against internal spring resistance. The ladder harness locking mechanism 380, 374, and 314 is designed to allow the ladder harness assembly 370 to lock at specific angles in order to hold the rails of the ladder 400 in a vertical orientation. Additionally, the ladder harness locking mechanism 380, 374, and 314 is a positive locking mechanism that resists accidental disengagement due to vibration or rotational torque of the ladder harness assembly 370. Furthermore, the ladder harness locking mechanism 380, 374, and 314 can be engaged and disengaged single-handedly and rapidly without the aid of tools, permitting fast leveling of the ladder 400 by a single user.

The overlapping open space within the base assembly 310 and ladder harness assembly 370 respectively permits a ladder user's foot to be placed on the first rung of the ladder 400 without significant obstruction. Unimpeded and normal placement of a user's foot on top of the central nine inches of the first rung of the ladder 400 is provided. The top surface of the second rung of the ladder 400 clears the top of the upper rung bracket 399 and therefore placement of a user's foot on that rung or any subsequent rung is entirely unimpeded. Since use of the lightweight quick-release ladder stabilizer and leveler 300 with the ladder 400 does not alter the stepping distance between the first and second rungs of the ladder 400, ANSI/OSHA requirements regarding rung spacing are met. Furthermore, since use of the lightweight quick-release ladder stabilizer and leveler 300 on level ground does not elevate the height of the first rung above fourteen inches from the ground, ANSI/OSHA ladder requirements regarding first rung height are met. Indeed, the lightweight quick-release ladder stabilizer and leveler 300 meets or exceeds all relevant ANSI A14 ladder requirements for ladder types III through IA.

As a result of the foregoing, stability and vertical rail orientation of ladder 400 can be achieved on a variety of ground surfaces and inclines by placing the base assembly 310 on a ground surface, mounting the ladder 400 onto the ladder harness assembly 370, rotating the ladder harness assembly 370 to achieve vertical ladder rail orientation, and locking the ladder harness assembly 370 to maintain vertical ladder rail orientation. Furthermore, the lightweight quick-release ladder stabilizer and leveler 300 is suited for use on stairways, an example of which is shown in FIG. 7. By extending the downstairs-side foot 334, the rotation of the ladder harness assembly 370 required to level the ladder 400 is reduced. This permits both feet 334 of the lightweight quick-release ladder stabilizer and leveler 300 to stand outside the rails of the ladder 400, thereby increasing the stability of the ladder 400.

The lightweight quick-release ladder stabilizer and leveler 300 of the aforementioned embodiment fits aluminum and fiberglass extension ladders of lengths up to 32 feet, encompassing approximately ninety percent of commercial extension ladders.

B.2. Alternate Embodiments

Alternative embodiments of the lightweight quick-release ladder stabilizer and leveler 300 include use of various materials or combinations of materials, such as aluminum, magnesium, or titanium, or alloys of the foregoing.

Alternate embodiments of the base assembly 310 include base assemblies of various widths to meet other size and stability requirements. Several other structural configurations, such as trusses or arches, are possible without departing from the spirit of the disclosed embodiments.

Alternative embodiments of the leg assemblies 330 and 350 include fixed non-telescoping feet. Various feet 334 shapes or forms, such as circular, non-pivoting, with holes to permit staking, or custom formed for particular applications are possible without departing from the spirit of the disclosed embodiments.

Alternative embodiments of the ladder harness assembly 370 include sidebars 354 spaced apart so that they 354 are directly behind the ladder 400 rails, or spaced wider than the rails.

Alternative embodiments of the lower rung retainer 364 use a differently formed wire clip 378 to suit various types of ladder rungs, or a wire clip 378 with a non-slip coating on its upper surface above the first rung.

Alternative embodiments of the lower rung retainer 364 retain the first rung of the ladder 400 in a horizontally oriented lower rung retaining channel attached to the bottom plate 372 so as to enclose the back, top and bottom surfaces of the first rung of a ladder. A channel locking pin is inserted through a hole in the lower rung retaining channel in front of the first rung in order to retain it in the lower rung retaining channel.

Alternative embodiments of the lower rung retainer 364 retain the first rung of the ladder 400 using a locking rod inserted through the hollow first rung and secured at each end to brackets attached to the bottom plate 372. In one such embodiment, the sidebars 354 are spaced apart so that they are directly behind the ladder 400 rails, and consequently placement of a user's foot on the first rung (and all subsequent rungs) of the ladder 400 is completely unimpeded.

While particular embodiments have been described, it is understood that, after learning the teachings contained in this disclosure, modifications and generalizations will be apparent to those skilled in the art without departing from the spirit of the disclosed embodiments. It is noted that the foregoing embodiments and examples have been provided merely for the purpose of explanation and are in no way to be construed as limiting. While the apparatus has been described with reference to various embodiments, it is understood that the words which have been used herein are words of description and illustration, rather than words of limitation. Further, although the apparatus has been described herein with reference to particular means, materials and embodiments, the actual embodiments are not intended to be limited to the particulars disclosed herein; rather, the system extends to all functionally equivalent structures, methods and uses, such as are within the scope of the appended claims. Those skilled in the art, having the benefit of the teachings of this specification, may effect numerous modifications thereto and changes may be made without departing from the scope and spirit of the disclosed embodiments in its aspects.

The invention claimed is:

1) A ladder stabilizer and leveler, comprising:
a) a base assembly;
b) two feet respectively attached to the left and right sides of said base assembly;
c) a ladder harness assembly pivotally attached to said base assembly, said ladder harness assembly comprising means for removably attaching said ladder harness assembly to a ladder;
d) retaining means for preventing separation of said ladder harness assembly from said base assembly; and
e) selective locking means for preventing rotation of said ladder harness assembly relative to said base assembly when said selective locking means is engaged.

2) The ladder stabilizer and leveler of claim 1, wherein the distance between said feet is at least one and a half times the width of an attached ladder.

3) The ladder stabilizer and leveler of claim 2, wherein said removable attachment means requires no permanent modification of an attached ladder.

4) The ladder stabilizer and leveler of claim 3, wherein said removable attachment means comprises a lower rung retainer for releasably retaining the first rung of a ladder.

5) The ladder stabilizer and leveler of claim 4, adapted to permit unimpeded placement of a user's foot on at least the central nine inches of the first rung of an attached ladder.

6) The ladder stabilizer and leveler of claim 5, wherein said retaining means comprises a retaining lip extending from said ladder harness assembly and overlapping a portion of said base assembly on the opposite side from said ladder harness assembly.

7) The ladder stabilizer and leveler of claim 6, wherein said selective locking means implements positive locking.

8) The ladder stabilizer and leveler of claim 7, wherein said base assembly is primarily constructed from formed aluminum alloy sheeting.

9) The ladder stabilizer and leveler of claim 7, wherein said base assembly is primarily constructed from extruded aluminum alloy tubing, and comprises a substantially arched member and a cross-brace thereof.

10) The ladder stabilizer and leveler of claim 7, adapted to permit unimpeded placement of a user's foot on the first rung of an attached ladder.

11) The ladder stabilizer and leveler of claim 7, wherein said feet are adapted to pivot in crosswise directions.

12) The ladder stabilizer and leveler of claim 7, wherein said lower rung retainer comprises a lower rung retainer wire clip adapted to releasably laterally retain the first rung of an attached ladder.

13) The ladder stabilizer and leveler of claim 7, wherein said selective locking means comprises a spring-loaded plunger attached to said ladder harness assembly and a locking plate attached to said base assembly, said locking plate has a plurality of slots for capturing the retractable end of said spring-loaded plunger.

14) The ladder stabilizer and leveler of claim 7, wherein said feet are extendably attached to said base assembly, whereby each foot may be individually extended or retracted.

15) The ladder stabilizer and leveler of claim 7, adapted to permit unimpeded placement of a user's foot on all rungs of an attached ladder.

16) The ladder stabilizer and leveler of claim 9, further comprising a bushing attached to said ladder harness assembly, said bushing adapted to transfer the weight of an attached ladder to said substantially arched member, whereby substantial ladder loads may be supported by a lightweight construction of said ladder stabilizer and leveler.

17) A ladder stabilizer and leveler, comprising:
a) a base assembly primarily constructed from formed aluminum alloy sheeting;
b) two feet respectively attached to the left and right sides of said base assembly, the distance between said feet is at least one and a half times the width of an attached ladder;
c) a ladder harness assembly pivotally attached to said base assembly, said ladder harness assembly comprising means for removably attaching said ladder harness assembly to a ladder without requiring permanent modification of the ladder, said removable attachment means comprising a lower rung retainer for releasably retaining the first rung of a ladder;
d) retaining means for preventing separation of said ladder harness assembly from said base assembly, said retaining means comprising a retaining lip extending from said ladder harness assembly and overlapping a portion of said base assembly on the opposite side from said ladder harness assembly; and
e) selective locking means for preventing rotation of said ladder harness assembly relative to said base assembly when said selective locking means is engaged, said selective locking means comprising a spring-loaded plunger attached to said ladder harness assembly and a locking plate attached to said base assembly, said locking plate having a plurality of slots for capturing the retractable end of said spring-loaded plunger, whereby unimpeded placement of a user's foot on all rungs of an attached ladder is permitted.

18) A ladder stabilizer and leveler, comprising:
a) a base assembly primarily constructed from extruded aluminum alloy tubing;
b) two feet respectively attached to the left and right sides of said base assembly, the distance between said feet is at least one and a half times the width of an attached ladder;
c) a ladder harness assembly pivotally attached to said base assembly, said ladder harness assembly comprising means for removably attaching said ladder harness assembly to a ladder without requiring permanent modification of the ladder, said removable attachment means comprising a lower rung retainer for releasably retaining the first rung of a ladder;
d) retaining means for preventing separation of said ladder harness assembly from said base assembly, said retaining means comprising a retaining lip extending from said ladder harness assembly and overlapping a portion of said base assembly on the opposite side from said ladder harness assembly; and
e) selective locking means for preventing rotation of said ladder harness assembly relative to said base assembly when said selective locking means is engaged, said selective locking means comprising a spring-loaded plunger attached to said ladder harness assembly and a locking plate attached to said base assembly, said locking plate having a plurality of slots for capturing the retractable end of said spring-loaded plunger,
whereby unimpeded placement of a user's foot on all rungs of an attached ladder is permitted.
